(19) United States
(12) Patent Application Publication
(10) Pub. No.: US 2008/0066331 A1
(43) Pub. Date: Mar. 20, 2008

(54) MAGNETOMETER CORRECTION SYSTEM AND METHOD

(75) Inventors: Daniel Brzezinski, Hudsonville, MI (US); Thomas S. Wright, Holland, MI (US); Mark J. Bussis, Hudsonville, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/782,538

(22) Filed: Jul. 24, 2007

Related U.S. Application Data
(63) Continuation-in-part of application No. 10/546,747, filed on May 23, 2006, now Pat. No. 7,322,117.
(63) Continuation-in-part of application No. 10/554,838, filed on Dec. 21, 2006.
(60) Provisional application No. 60/449,600, filed on Feb. 24, 2003.
(60) Provisional application No. 60/466,670, filed on Apr. 30, 2003.

(51) Int. Cl. G01C 17/38

(52) U.S. Cl. 33/356; 342/357.06; 702/92

(57) ABSTRACT

A compass correction system and method which utilizes data from the vehicle bus, vehicle sensors and vehicle subsystems to determine a compass correction factor.

### CROSS-REFERENCE TO RELATED PATENT APPLICATIONS

This application claims the benefit of priority to the following United States patent applications: U.S. patent application Ser. No. 10/554,838 titled “System and Method for Compensating for Magnetic Disturbance of a Compass by a Moveable Vehicle Accessory” filed on Apr. 30, 2004, which claims priority to U.S. Prov. Patent Application Ser. No. 60/466,670, titled “System and Method for Compensating for Magnetic Disturbance of a Compass by a Moveable Vehicle Accessory” filed on Apr. 30, 2003 and U.S. patent application Ser. No. 10/546,747 titled “System and Method for Compensating for Motor Magnetic Disturbance of a Compass Measurement” filed on Feb. 24, 2004, which claims priority to U.S. Prov. Patent Application Ser. No. 60/449,600, titled “System and Method for Compensating for Motor Magnetic Disturbance of a Compass Measurement” filed on Feb. 24, 2003, all of which are hereby incorporated by reference herein.

### BACKGROUND

Electronic compasses are commonly used in vehicles as an aid for direction finding and navigation. An electronic compass may be positioned in a vehicle on the instrument panel, the rearview mirror, in an overhead console, or at other locations within the vehicle. Typically, changes in the vehicle's magnetic field can cause erroneous compass displays. An electronic compass mounted in a vehicle will detect a variety of magnetic field values that can affect the compass reading. For example, a compass mounted in an instrument panel of a vehicle may detect interfering magnetic fields caused by various vehicle subsystems, such as the motor for a vehicle's HVAC system, an audio system, stepper motors for instrument panel gauges, front window defroster, etc. A compass mounted near the trunk of the vehicle (e.g., the rear package tray) may be affected by a magnetic field caused by a rear window defroster. A compass mounted in an overhead console may be affected by subsystems in close proximity to the magnetic sensors of the electronic compass. The vehicle's magnetism may also be affected when, for example, a vehicle door or other closure member, such as a trunk, hood, tailgate, etc., is opened while the vehicle is stopped.

Another source of magnetic fields in a vehicle that can cause errors in a compass reading is a moveable vehicle accessory, such as a sunroof, a seat or a convertible top. For example, the measurement of an electronic compass mounted in an overhead console of a vehicle or other appropriate location, may be affected by the operation of a sunroof (e.g., as the sunroof moves between various positions or the type of position of the sunroof, such as partially open, fully closed, etc.). Therefore, a need exists for a system and method for compensating for magnetic fields caused by vehicle accessory.

### SUMMARY

One embodiment relates to a system for correcting a vehicle compass measurement for an interfering magnetic field, the interfering magnetic field having an intensity sufficient to cause a compass measurement error. The system includes a magnetic field sensor for measuring a magnetic field and a compass control circuit coupled to the magnetic field sensor. The compass control circuit is configured to control the magnetic field sensor and to process the magnetic field measured by the magnetic field sensor. The compass control circuit is configured to determine a first magnetic field value and a second magnetic field value, such that the second magnetic field value is caused by a change in direction of the vehicle.

Another embodiment relates to a method for correcting a vehicle compass measurement for an interfering magnetic field, the interfering magnetic field having an intensity sufficient to cause a compass measurement error. The method includes monitoring an angular change of a vehicle and detecting a first magnetic field value. The method further includes determining a second magnetic field value caused by the changing of direction of the vehicle based on the angular change of the vehicle. The method also includes determining a correction value based on the first magnetic field value and the second magnetic field value. The method further includes storing the correction value in a memory.

Yet another embodiment relates to a compass correction system including a means for monitoring an angular change of a vehicle and a means for detecting a first magnetic field value. The compass correction system further includes a means for determining a second magnetic field value caused by the changing of direction of the vehicle based on the angular change of the vehicle. The compass correction system also includes a means for determining a correction value based on the first magnetic field value and the second magnetic field value. The method further including a means for storing the correction value.

Yet another embodiment relates to a vehicle compass system for compensating for magnetic field values, the vehicle compass system including a magnetic field sensor being configured to determine an orientation of the magnetic field sensor with respect to the Earth's magnetic field and to generate magnetic field data. The vehicle compass system further includes a control circuit coupled to the vehicle accessory and the magnetic field sensor. The control circuit being configured to receive a status signal from the vehicle accessory indicating whether the vehicle accessory has a status change. The control circuit further being configured to receive magnetic field data from the magnetic field sensor and to receive a vehicle angular change signal from a vehicle angular change monitor. The system is configured so that when the vehicle angular change signal indicates a change in a vehicle angle, the control circuit is configured to determine a first magnetic field value and a second magnetic field value, such that the second magnetic field value is caused by a change in direction of the vehicle.

### BRIEF DESCRIPTION OF THE DRAWINGS

FIG. 1 is a perspective view of a motor vehicle that includes a number of vehicle systems, including a compass system, according to one exemplary embodiment;

FIGS. 2A-B are graphical models of magnetic fields of the Earth and North America respectively, according to exemplary embodiments;

FIG. 3 is a block diagram of an electronic compass system, according to one exemplary embodiment;

FIGS. 4A-B illustrate a method for determining magnetic field values and compensating for these magnetic field values in a compass, according to one exemplary embodiment;

FIG. 5 illustrates another method for determining magnetic field values and compensating for these magnetic field values in a compass, according to one exemplary embodiment;

FIG. 6 illustrates an exemplary method for determining a magnetic field change caused by a vehicle changing direction, according to an exemplary embodiment;

FIGS. 7A-D are illustrations of vehicle movements with and without moveable vehicle accessory movement; according to exemplary embodiments;

FIG. 8 illustrates a method for compensating for magnetic field value of a compass by a moveable vehicle accessory while the vehicle is changing direction, according to an exemplary embodiment;

FIG. 9 is a block diagram of an instrument panel, including an electrical compass, according to an exemplary embodiment;

FIG. 10 shows an exemplary waveform representing the behavior of a magnetic field generated by the motion of a stepper motor; and

FIG. 11 illustrates a method for compensating for interfering magnetic fields, according to an exemplary embodiment.

### DETAILED DESCRIPTION OF THE EXEMPLARY EMBODIMENTS

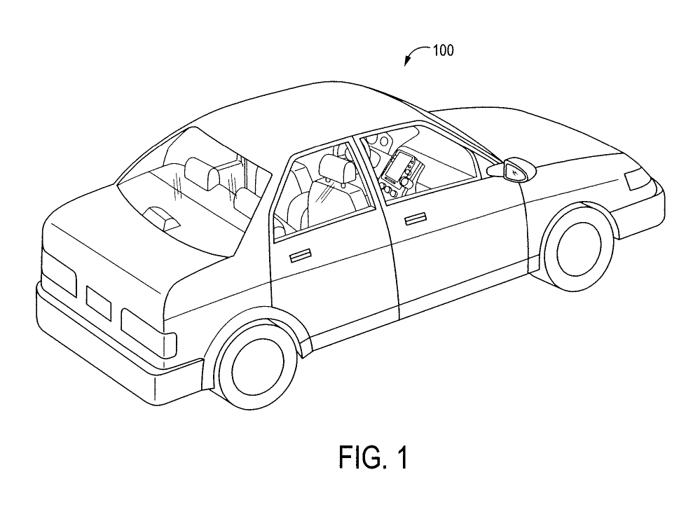

Referring to FIG. 1, a vehicle 100 includes a number of subsystems for user convenience. Vehicle 100 generally includes an electronic compass system, a heating, ventilation, and air-conditioning system (“HVAC system”), a sound system, and an in-vehicle control system. The electronic compass system, HVAC system, and sound system may be coupled to in-vehicle control system, which is capable of controlling and monitoring the systems, automatically or by a manual user command. It is noted that in various exemplary embodiments, vehicle 100, the compass system, the HVAC system, and the sound system may be of any past, present, or future design that is capable of interacting with in-vehicle control system.

In an exemplary embodiment, in-vehicle control system may be capable of accessing data files from a remote source over a communication link. For example, in-vehicle control system may access magnetic-field models. In an exemplary embodiment, the magnetic-field models used may be succinct mathematical descriptions of the Earth's surficial magnetic field. The magnetic field models may be constructed by fitting a set of basis functions, usually spherical harmonics or spherical caps, to magnetic data, such as those collected at United States Geological Society's observatories. The models are interpolators for estimating the field between measurement locations and between measurement times. The calculations for these models are available at http://geomag.usgs.gov/models/.

These models published by the United State Geological Society have at least three sources of error. First, these models are only approximations of the magnetic field. Second, these models become outdated every few years because the Earth's magnetic field shifts. This magnetic field shift can be one degree every several years. Third, these models are predictive, in that they are based on data collected in the recent past, preceding their construction, and are intended to represent the field in the near future, following their construction.

Further, magnetic-field models and charts have limitations. Since the magnetic field is extremely complicated, in both space and time, magnetic-field models are, by practical necessity, something of an approximation of the actual magnetic field. For example, global models of the field, such as the IGRF, do not account for very local magnetization. Indeed, there is no way that they could, since many geological formations, and for that matter many rocks, are magnetized, if only partially. Moreover, the models do not fully account for magnetic-field ingredients generated by ionospheric and magnetospheric electric currents, since these can create essentially unpredictable, localized and transient perturbations to the main field, particularly at high latitudes.

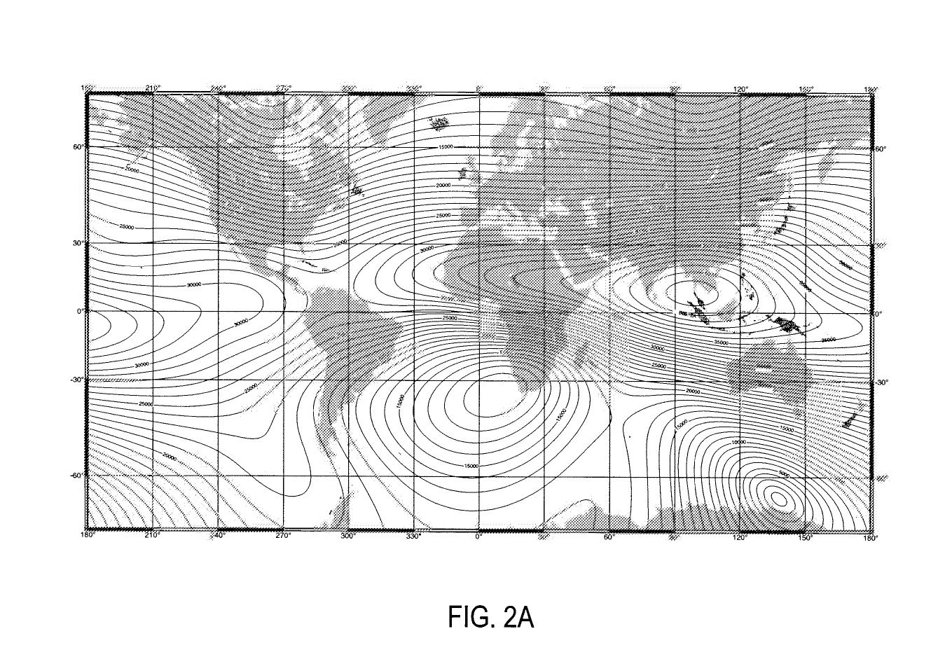

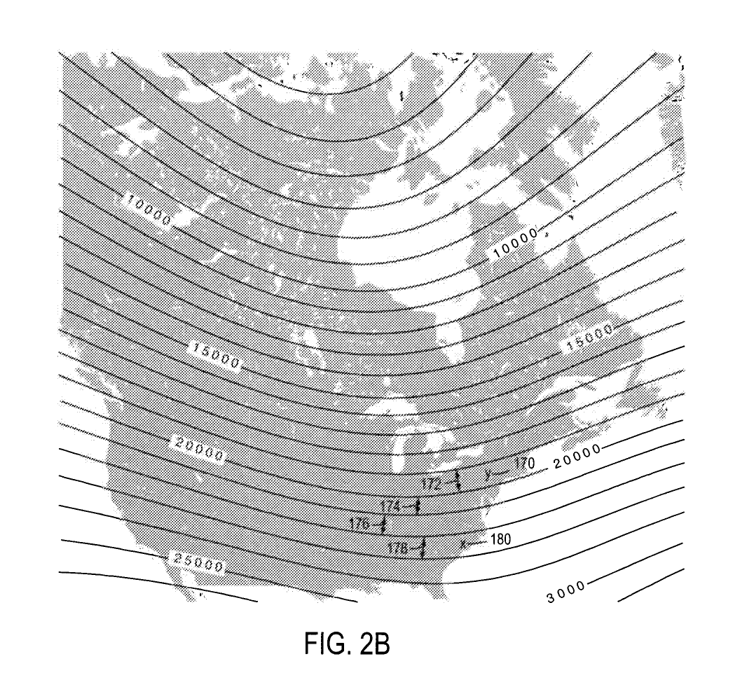

FIG. 2A shows a magnetic field map of the Earth. FIG. 2B shows a magnetic field map of a portion of the Earth, focusing on North America. In another exemplary embodiment, the in-vehicle control system and/or the compass system is configured to retrieve the geographic zone error factor from an onboard database and apply the geographic zone error factor to the compass system. The geographic zone error factor is based on the location of the compass derived from a GPS signal. In an exemplary embodiment, the onboard database is configured to update the geographic zone error factors via the internet to ensure that the most recent data is being utilized. In another exemplary embodiment, the compass system could download the geographic zone error factors directly via the internet with no requirement for an onboard database.

In another exemplary embodiment, the compass system would continually, or at a predetermined interval, recalibrate the system based on which geographic zone the compass was located in. In this exemplary embodiment, an owner could drive vehicle 100 across a geographic zone (i.e. cross country trip) or move to a new geographic zone and the compass system would automatically recalibrate to the new geographic zone upon entry into this new geographic zone. In this exemplary embodiment, a location signal (i.e., GPS signal) may determine the position of vehicle 100.

In FIG. 2B, a driver could start a trip from a first position 170 in a first geographic zone 172 to a second position 180 in a second geographic zone 178. The compass system would enter new geographic zone error factors upon entering a third geographic zone 174, a fourth geographic zone 176 and second geographic zone 178. In another exemplary embodiment, the compass system could be configured to provide buffer zones around the geographic zones to minimize the number of times the system recalibrates. The buffer zones could be configured to reduce the memory and/or processing requirements for vehicle 100 that was located at the boundary line of two geographic zones.

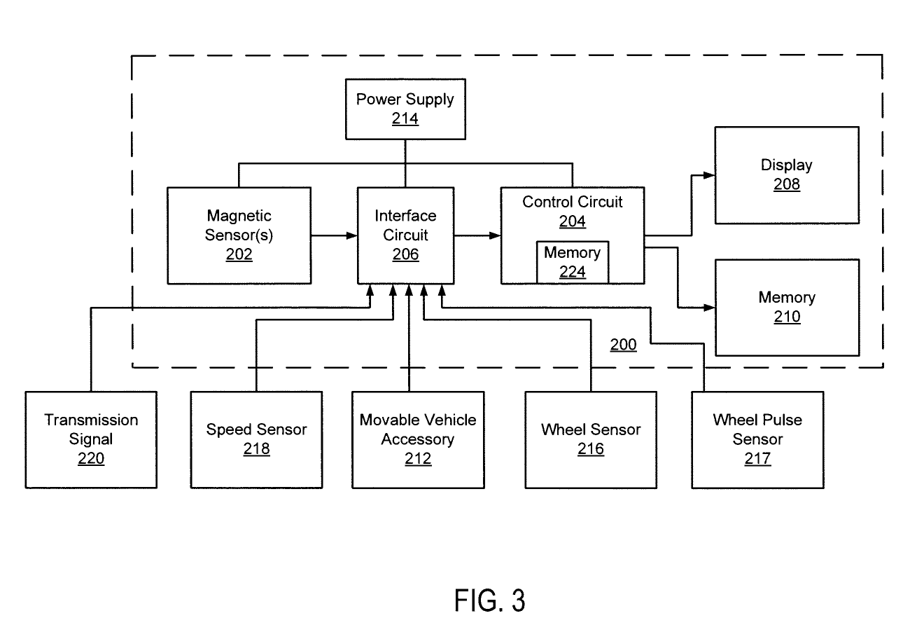

FIG. 3 is a block diagram of an electronic compass system in accordance with an embodiment. Electronic compass 200 includes a magnetic field sensor 202, a control circuit 204, an interface circuit 206, a display 208 and a memory 210. One or more components of electronic compass 200 may be mounted in a vehicle inside an interior vehicle element, such as an overhead console, a rearview mirror, a visor, a dashboard, or other appropriate location. Magnetic field sensor 202 may be, for example, a flux gate type sensor, a magneto inductive sensor, a magneto resistive sensor, or other device which can sense the Earth's magnetic field and provide signals representative thereof to the compass control circuit 204. Magnetic field sensor 202 is coupled to control circuit 204 through an electrical interface circuit 206. Electrical interface circuit 206 can take various forms and can comprise electrical conductors, buffers, amplifiers, and/or other electrical components. Control circuit 204 may include one or more analog and/or digital electrical or electronic components, and may include a microprocessor, microcontroller, application-specific integrated circuit (ASIC), programmable logic, and/or other analog and/or digital circuit elements configured to perform various input/output, control, analysis, and other functions to be described herein.

Interface circuit 206 and control circuit 204 are coupled via serial communication's lines and process electrical signals supplied by magnetic field sensor 202, a moveable vehicle accessory input 212, a moveable vehicle accessory output, a non-moveable vehicle accessory input or a non-moveable vehicle accessory output. Control circuit 204 has internal control circuit memory 224 and may also be coupled to a nonvolatile memory circuit 210 for storing data. In an exemplary embodiment, control circuit 204 continuously stores the magnetic field data provided by magnetic field sensor 202 during operation in the memory circuit 210. When electronic compass 200 is turned off, compass data can be stored and identified in the memory circuit 210 (e.g., the last magnetic field reading of the magnetic field sensor 202, calibration data, etc., before the ignition was turned off). Display 208 is coupled to control circuit 204 and used to display heading information to the operator of vehicle 100. A power supply circuit 214 provides operating voltage to the various electrical components of the compass system.

In an exemplary embodiment, interface circuit 206 includes a monitoring circuit. Monitoring circuit monitors the vehicle accessories. In another exemplary embodiment, monitoring circuit may be designed to control the vehicle accessories. In an exemplary embodiment, the monitoring circuit and control circuit 204 may be configured to control the vehicle accessories.

As mentioned, various vehicle accessories or wiring harnesses may be positioned sufficiently close to magnetic field sensor 202 so as to interfere with the magnetic field sensed by magnetic field sensor 202. For example, the operation of a stepper motor in an instrument panel, the operation of a vehicle HVAC system, or the opening of a door or other closure member when vehicle 100 is stopped may each cause errors in the reading of electronic compass 200. Another source of an interfering magnetic field is a moveable vehicle accessory such as a sunroof. A compass circuit or magnetic field sensors mounted in, for example, an overhead console of vehicle 100 may be sufficiently close to a sunroof assembly that electronic compass 200 reading is affected by the position and movement of the sunroof. The field value caused by a sunroof (or other similar moveable vehicle accessory) typically is unpredictable, since the sunroof moves in two directions (e.g., from the open or closed position). The system of FIG. 3 is configured to compensate for the magnetic field value caused by a moveable vehicle accessory such as a sunroof. The following discussion will refer to a sunroof, although it should be understood that the system and method disclosed herein may also apply to other moveable vehicle accessories such as a seat or convertible top. For example, a compass mounted under a rear seat of vehicle 100 may be affected by magnetic field values caused by movement of the seat or a compass mounted in a rearview mirror may be affected by magnetic field values caused by the opening and/or closing of a convertible top.

In FIG. 3, a moveable vehicle accessory input 212 (e.g., a sunroof) is coupled through interface circuit 206 to the control circuit 204. In one embodiment, input 212 is coupled to a motor switch of a sunroof assembly to detect whether the sunroof is moving or not moving (i.e., whether the sunroof is changing position). Alternatively, input 212 is coupled to a position sensor that may be coupled to the motor switch of the sunroof to determine whether the sunroof is moving. In yet another embodiment, the position sensor is also configured to detect the position of the sunroof as well as when the position of the sunroof is changing. The movement and/or position data provided to input 212 is used by control circuit 204 in conjunction with the magnetic field data provided by the magnetic field sensor 202 to determine magnetic field values caused by the movement and/or position of the sunroof and to compensate for the magnetic field value.

In an exemplary embodiment, there are two types of vehicle accessories. Vehicle accessories that have consistent magnetic field signatures or cause consistent magnetic field correction factors are called stable vehicle accessories. Stable vehicle accessories include but are not limited to a defroster, a stereo, a light, or a navigational system. Vehicle accessories that have inconsistent magnetic field signatures or cause inconsistent magnetic field correction factors are called unstable vehicle accessories. Unstable vehicle accessories include but are not limited to a sunroof, an electric window, an electric seat, or a HVAC system. In an exemplary embodiment, a compass error may be caused by an external magnetic influence. The external magnetic influence may be a bridge, hills, railroad tracks, or buildings.

In an exemplary embodiment, a short term magnetic influence may occur when vehicle 100 passes over a bridge or railroad tracks. This short term magnetic influence may also occur when vehicle 100 passes by a building. This short term magnetic influence is only transient in nature, which may allow for this short term magnetic influence to be filtered out. In an exemplary embodiment, a short term magnetic influence can be determined utilizing a time sensitive procedure. This time sensitive procedure may require waiting a predetermined amount of time to determine whether the magnetic influence has ceased. In an exemplary embodiment, the predetermined amount of time may be one second, five seconds, ten seconds, thirty seconds or sixty seconds. In another exemplary embodiment, the process to correct the short term magnetic influence can be to apply a correction factor, filter out the short term magnetic influence or both.

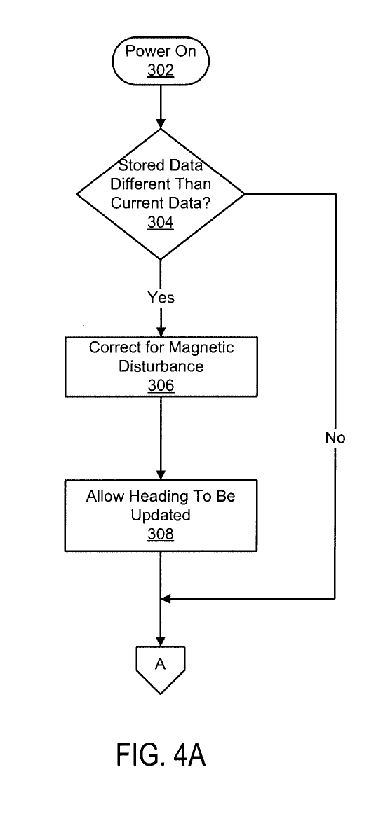

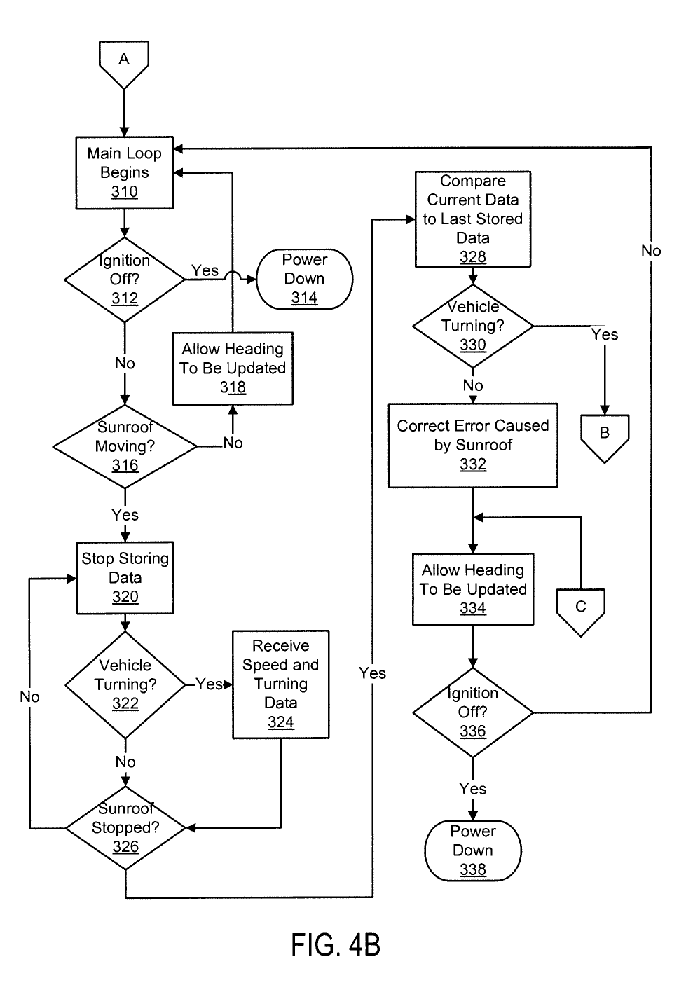

FIGS. 4A-B illustrate a method for compensating for magnetic field value of a compass by a moveable vehicle accessory in accordance with an exemplary embodiment. As mentioned above with respect to FIG. 3, control circuit 204 continuously processes and/or stores the magnetic field data provided by magnetic field sensor 202 while electronic compass 200 is operating. When electronic compass 200 is powered down (i.e., when the ignition is turned off), the last magnetic field reading from magnetic field sensor 202 is stored and identified in memory 210. In FIG. 4A, the compass system is powered up by, for example, turning on the vehicle ignition (step 302). The stored magnetic field data is compared to the current magnetic field data provided by magnetic field sensor 202 (step 304). The sunroof may have been moved while the compass system was powered down (i.e., when the vehicle ignition is turned off), which may cause a field value that should be compensated for by updating compass calibration values. If the stored magnetic field data is different than the current magnetic field data at step 304, then the difference between the stored and current magnetic field data is added to a compass calibration value, Vref, to compensate for the movement of the sunroof while the system was powered down (step 306). If the stored and current magnetic field data are not different at step 304, the process proceeds to step 310.

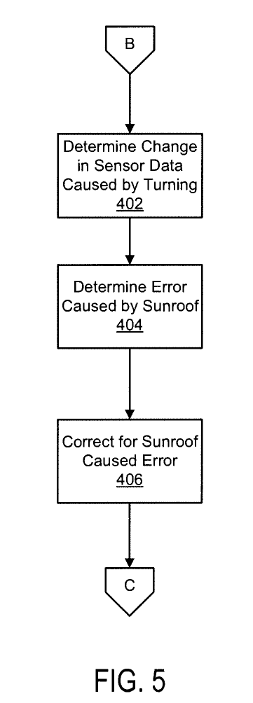

As mentioned above, control circuit 204 is coupled to input 212 from the sunroof assembly and is used to detect whether or not the sunroof is moving. The system initiates a system status check (step 310). The system determines whether the ignition is off (step 312). If the ignition is off, the system powers down (step 314). If the ignition is on, the system moves to step 316. The system determines whether the sunroof is moving (step 316). If the sunroof is moving at step 316, control circuit 204 stops storing the magnetic field data provided by magnetic field sensor 202 (step 320). If the sunroof is not moving, the compass heading is updated (step 318) and the process returns to step 310. If the vehicle is not turning (i.e., moving in a straight direction), the process proceeds to step 326, where it is determined whether the sunroof has stopped moving (step 322). If the vehicle is turning at step 322, control circuit 204 (see FIG. 3) begins to store wheel position data received from a wheel sensor 216 or a wheel pulse sensor 217 and speed data from a speed sensor 218 (step 324). This data is used to determine the magnetic field while vehicle 100 is changing direction, as discussed further below with respect to FIG. 5. In an exemplary embodiment, this data may also be used to approximate the angle of the turn and apply a correction factor to the compass.

Control circuit 204 stops storing the magnetic field data until it receives an indication at input 212 at step 326 that the sunroof has stopped moving (step 320). The input signal may also indicate the current position of the sunroof (e.g., partially open, completely open, etc.). Once the sunroof has stopped moving at step 326, control circuit 204 stores the current magnetic field data from magnetic field sensor 202 and compares it to the last magnetic field data stored before the sunroof began moving (step 328). If vehicle 100 is moving in a straight direction at step 330 (i.e., the vehicle is not turning) as determined from wheel sensors, the difference between the current and stored magnetic field data is added to the compass calibration values to compensate for the movement and new position of the sunroof (steps 332 and 334). As mentioned above, a signal from a sensor 216 (see FIG. 3) coupled to the wheel sensor of the vehicle may be used to indicate when vehicle 100 is changing direction. The system determines if the vehicle ignition has been turned off (step 336). If the vehicle ignition has not been turned off, the process returns to step 310. If the ignition has been turned off at step 336, the compass system will power down (step 338).

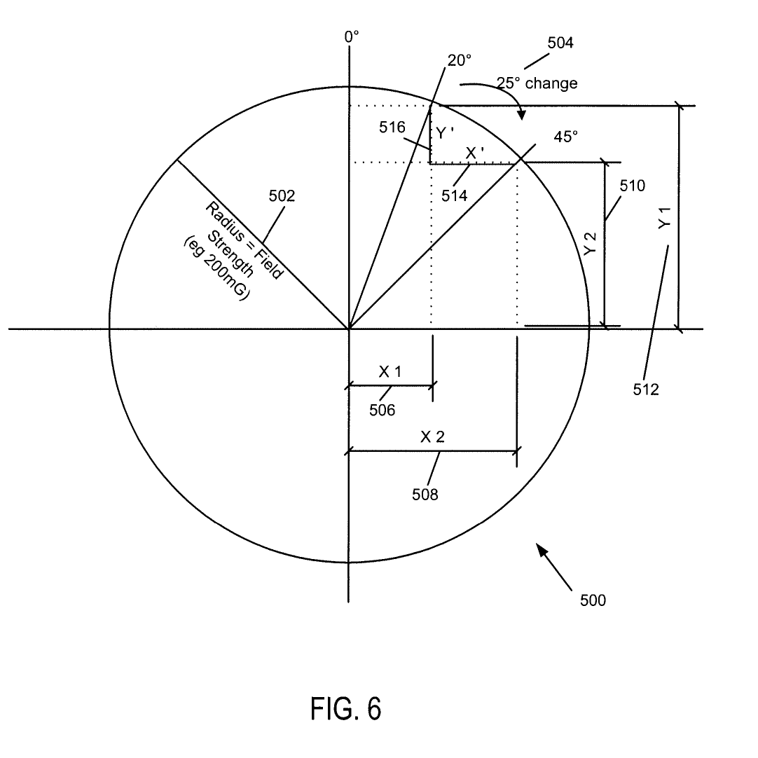

Returning to FIG. 4B, it is determined whether vehicle 100 is changing direction (step 322). Turning vehicle 100 also causes a change in the magnetic field measured by electronic compass 200. If vehicle 100 is turning, the system may be configured to determine how much of the total measured magnetic field is due to vehicle 100 turning and how much is due to the movement and/or position of the sunroof assembly. Accordingly, the appropriate correction may be made for the error caused by the sunroof assembly. Whether or not vehicle 100 is turning may be determined based on, for example, a signal from sensor 216 or wheel pulse sensor 217 coupled to the vehicle wheel sensor and/or a speed signal from speed sensor 218 (see FIG. 3). A transmission signal 220 (see FIG. 3) may also be used in combination with the speed and wheel sensor data. Transmission signal 220 provides data regarding the state (e.g., forward, reverse) of the transmission of vehicle 100. Alternatively, in vehicles 100 with an ABS braking system, a wheel velocity and/or distance measurement for each front wheel may be compared. Typically, each of the front wheels will travel a different distance if vehicle 100 is turning. If vehicle 100 is turning at step 322, various methods may be used to determine the error caused by the sunroof assembly and the magnetic field change caused by the turning of vehicle 100 as discussed further below with respect to FIGS. 5 and 6.

As mentioned above, if vehicle 100 is turning when the sunroof is moving at step 322, control circuit 204 (see FIG. 3) begins to store the speed and wheel sensor data. Referring now to FIG. 5, wheel sensor 216 data and speed sensor 218 data are used to determine the magnetic change due to the turning of vehicle 100 (step 402). In one embodiment, the size and/or distance of the turn and the expected strength of the Earth's magnetic field at the location of vehicle 100 may be used to determine a magnetic field due to the turning of vehicle 100. For example, the size of the turn in degrees (e.g., 30°) is converted to a distance using a known conversion function. This distance value is then multiplied by the expected Earth's magnetic field at the location of vehicle 100 to determine the magnetic change caused by the turn of vehicle 100.

The magnetic change caused by the sunroof is determined by comparing the magnetic change caused by the turning of vehicle 100 (step 402) to the magnetic shift determined at step 328 of FIG. 4B for the time period the sunroof was moving (step 404). The difference between these two values is the magnetic field value caused by the sunroof. Once the error caused by the sunroof has been determined, the system makes a correction for the error caused by the sunroof (step 406). For example, the amount of magnetic change or shift caused by the sunroof may be added to or subtracted from the compass calibration values. The process then returns to step 334 of FIG. 4B.

In an exemplary embodiment, the system may be configured to determine that vehicle 100 is changing vehicle's 100 angular direction based on a GPS signal, a wheel sensor, a gyro, an accelerometer, or a remote magnetic sensor. It should be noted that any way known to a person of ordinary skill in the art to determine vehicle's 100 angular change in direction is hereby incorporated. The GPS signal may be configured to include a location position, a heading or speed data.

In FIG. 6, a graph 500 shows an example in which vehicle 100 is driving at a heading of 20° and then turns to a heading of 45° the angle/degrees of the turn made by vehicle 100 may be determined based on the wheel sensor signal, the speed of the vehicle, the number of revolutions of the tires, etc. using known methods. In the example shown in FIG. 6, vehicle 100 has made a 25° turn (504). Assuming electronic compass 200 includes a first and a second magnetic sensor (e.g., two channels), the magnetic change for each channel, X′(514) and Y′ (516) may be determined based on the field strength and the starting and ending angles of the turn. A field strength 502 is represented by the radius of the circle in FIG. 6.

The magnetic change for each channel, X′(514) and Y′ (516) may be determined using the following equations:
X′=X2−X1 (1)
Y′=Y2−Y1 (2)
Where
X1=Field strength*sin(starting angle) (3)
X2=field strength*sin(ending angle) (4)
Y1=Field strength*cos(starting angle) (5)
Y2=Field strength*cos(ending angle) (6)

Depending on the quadrant and the magnitude of the heading difference, the signs of the above equations may change. In addition, in other embodiments, the sine and cosine functions may be interchanged in the equations. In the specific example shown in FIG. 6, the starting angle is 20°, the ending angle is 45° and field strength 502 is 200 mG. Accordingly, applying these values to the above equations:
X′=73 mG; and
Y′=47 mG
In FIG. 5, the magnetic change caused by the sunroof is determined by comparing the magnetic change caused by the turning of the vehicle (X′ and Y′) determined at step 402 to the magnetic shift determined at step 328 (see FIG. 4B) for the time period the sunroof was moving (step 404). The difference between these two values for each channel is the magnetic field value caused by the sunroof for each channel. This difference is used as a correction value. Once the error caused by the sunroof has been determined, the system makes a correction for the error caused by the sunroof at step 406 using the correction value, so that the magnetic change caused by turning vehicle 100 may be used to update the heading. For example, the amount of magnetic change or shift caused by the sunroof may be added to or subtracted from the compass calibration values. Alternatively, the correction value may be applied to the magnetic field data measured by the sensor(s). The process then returns to step 334 of FIG. 4B and the heading may be updated.

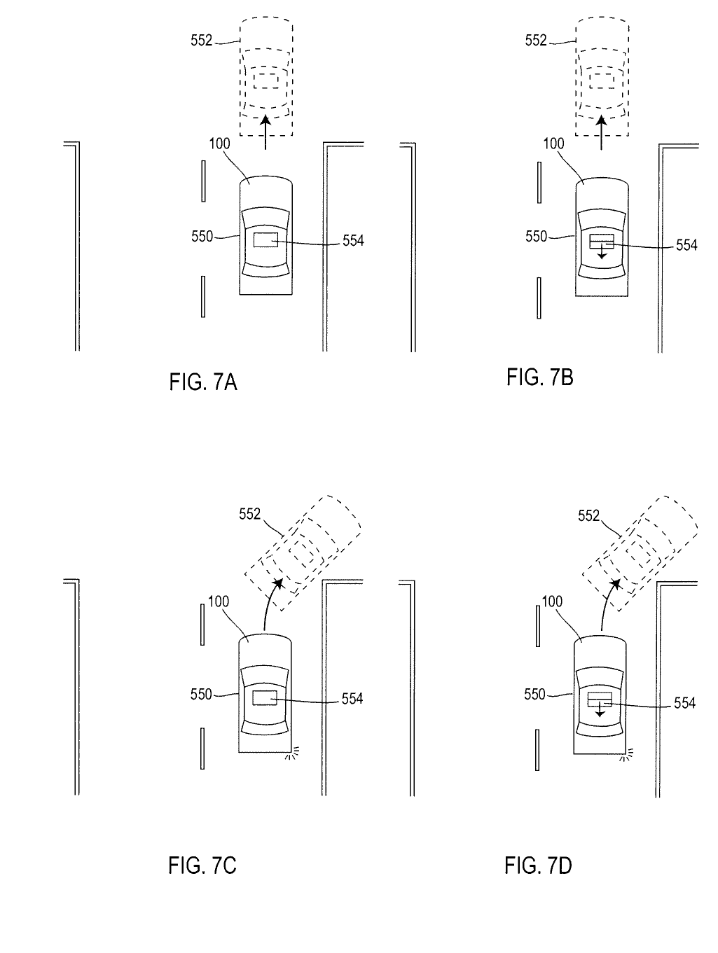

FIGS. 7A-D illustrate vehicle 100 movement with and without moveable vehicle accessory movement. In FIG. 7A, vehicle 100 moves in a straight line from a first position 550 to a second position 552, while a moveable vehicle accessory 554 is stationary. In FIG. 7A, electronic compass 200 would not be adjusted barring any unforeseen system characteristics. In FIG. 7B, vehicle 100 moves in a straight line from first position 550 to second position 552, while moveable vehicle accessory 554 is moving. In FIG. 7B, electronic compass 200 would be adjusted based on any difference between magnetic field sensor readings at first position 550 and magnetic field sensor readings at second position 552. In an exemplary embodiment, the adjustment to electronic compass 200 may also be derived from a data base of magnetic field values for a particular moveable vehicle accessory 554, an average of these values and/or data gathered from actual accessory usage during vehicle 100 operations. In FIG. 7C, vehicle 100 turns from first position 550 to second position 554, while moveable vehicle accessory 554 is stationary. In FIG. 7C, electronic compass 200 would not be adjusted barring any unforeseen system characteristics. In FIG. 7D, vehicle 100 turns from first position 550 to second position 554, while moveable vehicle accessory 554 is moving. In FIG. 7D, the change in magnetic field sensor 202 readings due to vehicle 100 turning would be calculated. Electronic compass 200 would be adjusted based on the difference of magnetic field sensor 202 readings due to vehicle 100 turning and the actual magnetic field sensor change measured from first position 550 and second position 552. In an exemplary embodiment, the adjustment to electronic compass 200 may also be derived from a data base of magnetic field values for a particular moveable vehicle accessory 554; an average of these values and/or data gathered from actual accessory usage during vehicle 100 operations. In an exemplary embodiment, the adjustment to electronic compass 200 may be derived from a GPS signal, wheel sensor data, a gyro data, an accelerometer data, or a remote magnetic sensor data.

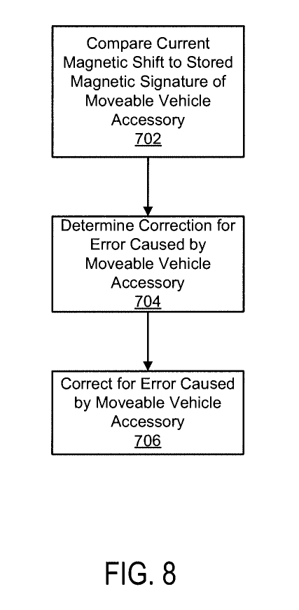

FIG. 8 illustrates an alternative method for compensating for the magnetic field value caused by moveable vehicle accessory 554, while vehicle 100 is changing direction. The current magnetic shift determined for the time period moveable vehicle accessory 554 is moving is compared to a stored magnetic signature for moveable vehicle accessory 554 (step 702). For example, electronic compass 200 may store in memory 210 the magnetic shifts associated with the common positions of moveable vehicle accessory 554 (i.e., an open position, a partially open position, etc.). Based on the position information provided by the moveable vehicle accessory input, control circuit 204 may retrieve from memory 210 a magnetic shift associated with that position. Alternatively, a magnetic signature may be determined by averaging the magnetic shifts from a predetermined number of prior operations of moveable vehicle accessory 554. In yet another embodiment, the magnetic signature is based on maximum and minimum magnetic fields caused by the movement of moveable vehicle accessory 554. At the initial calibration of electronic compass 200, moveable vehicle accessory 554 may be cycled from closed to fully open. Electronic compass 200 records the maximum and minimum magnetic fields measured during this cycle. The maximum and minimum values may be updated when moveable vehicle accessory 554 is cycled from closed to fully open when the vehicle speed is zero.

The magnetic shift caused by the current movement of moveable vehicle accessory 554 is compared to a stored magnetic signature for electronic compass 200 (step 702). The comparison is used to determine a correction value for electronic compass 200 calibration values (step 704). For example, the stored magnetic signature data for electronic compass 200 may indicate the maximum shift measured by electronic compass 200 for the movement of moveable vehicle accessory 554 from closed to fully open is 50 mG. The magnetic shift caused by turning of vehicle 100 (e.g., a 90° turn) may be significantly greater than the maximum magnetic shift caused by moveable vehicle accessory 554. If the measured magnetic shift is significantly more than the stored maximum value for moveable vehicle accessory 554, it may indicate that vehicle 100 has turned and the control circuit can use the maximum value (e.g., 50 mG) to correct the calibration values. The correction is applied by, for example, adding the correction to the compass calibration values (step 706).

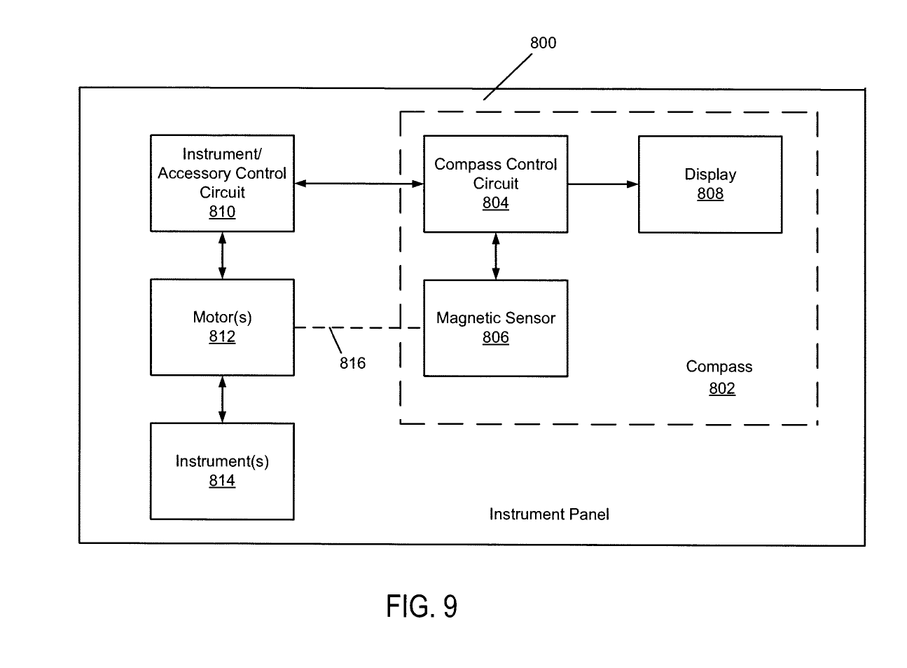

FIG. 9 is a block diagram of an instrument panel including a compass, according to an exemplary embodiment. An instrument panel 800 includes a compass 802 and an instrument control circuit 810. Instrument panel 800 also includes motor(s) 812 (e.g., stepper motors, servo motors, etc.) and instrument(s) 814 (e.g., gauges for speed, rpm, etc.). Instrument control circuit 810 is used to control the various devices of instrument panel 800, including the motion of the motor(s) 812. Instrument control circuit 810, therefore, is able to determine the position of the motor(s) 812 during operation.

Compass 802 includes a compass control circuit 804, a magnetic sensor(s) 806 and a display 808. Magnetic sensor 806 can be a flux gate type sensor, a magneto inductive sensor, a magneto resistive sensor, or other device which can sense the Earth's magnetic field and provide signals representative thereof to compass control circuit 804. The sensor selected will require signal conditioning to provide a signal format to compass control circuit 804 data input in a conventional manner known to those skilled in the art, such as described in U.S. Pat. No. 5,878,370, incorporated herein by reference. Instrument control circuit 810 and compass control circuit 804 may comprise a printed circuit board and a microprocessor. Alternatively, instrument control circuit 810 and compass control circuit 804 may comprise one or more analog and/or digital electrical or electronic components, and may include a microprocessor, microcontroller, application-specific integrated circuit (ASIC), programmable logic, and/or other circuit elements.

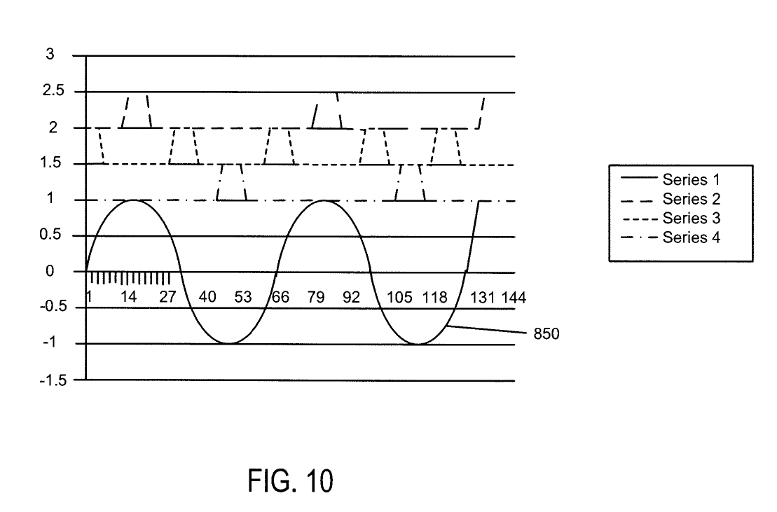

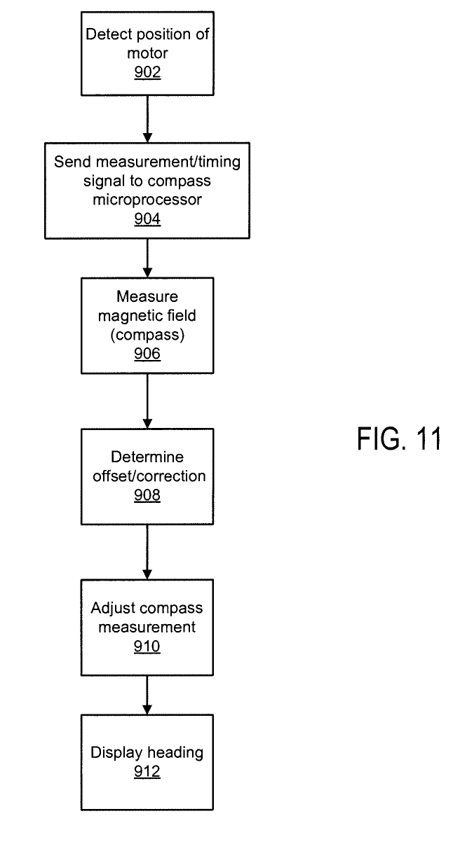

Stepper motor 812 is positioned sufficiently close to magnetic sensor 806 as indicated by dashed line 816 so as to interfere with the magnetic field sensed by magnetic sensor 806. As mentioned, stepper motor 812 can generate magnetic fields which can interfere with the magnetic sensors of compass 802 so as to cause an erroneous direction display on compass display 808 at least temporarily due to the interfering magnetic field. The magnetic field value of stepper motor 812 is generally periodic when stepper motor 812 is moving (e.g., when a needle of a gauge in the instrument display is moving). The magnetic field created by stepper motor 812 in close proximity to magnetic sensor 806 resembles a Sine (or Cosine) wave 850, as shown in FIG. 10, when stepper motor 812 is moving. When stepper motor 812 has stopped, the magnitude of the magnetic field sensed by compass magnetic sensor 806 from stepper motor 812 will reside at a point (e.g., an amplitude) on the Sine (or Cosine) wave. In order to compensate for the magnetic field value caused by a stepper motor, instrument control circuit 810 and compass control circuit 804 are configured to determine a compensation or offset value for correcting the temporary magnetic field value as described in connection with FIG. 11 below.

FIG. 11 illustrates a method for compensating for interfering magnetic fields in accordance with an exemplary embodiment. As mentioned above, instrument control circuit 810 is coupled to stepper motor 812 and controls the motion of stepper motor 812. Accordingly, instrument control circuit 810 is able to monitor the position of stepper motor 812 at all times, as well as whether stepper motor 812 is moving or stopped. The position of stepper motor 812 is detected by instrument control circuit 810 (step 902). The position of stepper motor 812 may include data regarding the rotational position of the magnet of stepper motor 812, whether stepper motor 812 is moving or is stopped, the position (e.g., amplitude) of stepper motor 812 magnetic field waveform, and so on. Based on the position of stepper motor 812, instrument control circuit 810 sends a measurement signal to compass control circuit 804 (step 904). The measurement signal instructs compass 802 to take a measurement, or not to take a measurement, of the Earth's magnetic field using magnetic sensor 806.

If stepper motor 812 is moving, instrument control circuit 810 instructs compass 802 to take a measurement at times corresponding to the peaks, valleys and center points of stepper motor 812 magnetic field waveform. Alternatively, instrument control circuit 810 can provide a measurement signal instructing compass 802 to take a measurement at a consistent point on stepper motor 812 magnetic waveform. Preferably, the consistent point corresponds to the maximum and/or minimum of stepper motor 812 magnetic field waveform. In one embodiment, instrument control circuit 810 instructs compass 802 when to begin and end a measurement.

If stepper motor 812 is stopped, the magnetic field offset generated by stepper motor 812 is stable. Preferably, instrument control circuit 810 provides a measurement signal that controls when stepper motor 812 is stopped, e.g., restricting the motor to stop only at times corresponding to peaks, valleys and midpoints of stepper motor 812 magnetic field waveform. Accordingly, these are the points at which the magnetic field for a stationary stepper motor will be measured.

Compass 802 takes a measurement of the Earth's magnetic field based on the instruction provided by instrument control circuit 810 (step 906). An offset is determined to correct compass 802 measurement for the field value caused by stepper motor 812 (step 908). As discussed above, in one embodiment instrument control circuit 810 instructs compass 802 to take a magnetic measurement in a symmetric part of stepper motor 812 magnetic field waveform during stepper motor 812 cycle, e.g., the peaks, valleys and center points of stepper motor 812 magnetic field waveform. Compass control circuit 804 can average the data collected at these points to determine an offset for the magnetic field generated by stepper motor 812. Alternatively, instrument control circuit 810 can provide a measurement signal instructing compass 802 to take a measurement at a consistent point on the magnetic waveform. In an exemplary embodiment, compass control circuit 804 is instructed to take measurements when the magnetic field waveform is at its maximum and/or minimum. Compass control circuit 804 can provide the measurements, such as maximum and minimum field strength, to instrument control circuit 810. Instrument control circuit 810 uses this magnetic information to determine an offset for each data point measured by compass 802. In one embodiment, the offset or correction determined by either compass control circuit 804 or instrument control circuit 810 is stored in memory.

Compass 802 measurement is adjusted based on the compensation or offset value determined by instrument control circuit 810 and/or compass control circuit 804 (step 910). The adjusted magnetic measurement is then used to generate a display showing the heading of vehicle 100 (step 912).

It is also important to note that the construction and arrangement of the elements of the electrical compass and instrument panel, as shown, are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited herein. Accordingly, all such modifications are intended to be included within the scope of the present disclosure as described herein. The order or sequence of any process or method steps may be varied or re-sequenced according to alternative embodiments. Other substitutions, modifications, changes and/or omissions may be made in the design, operating conditions and arrangement of the preferred and other exemplary embodiments without departing from the exemplary embodiments of the present disclosure as expressed herein.

It should be noted that the calibration method disclosed herein can be combined with one or more of the calibration methods set forth in U.S. Pat. Nos. 5,737,226, 5,878,370, 5,953,305 or 6,301,794, which are herein incorporated by reference. The order or sequences of any process or method steps may be varied or re-sequenced according to alternative embodiments.

What is claimed is:

1. A system for correcting a vehicle compass measurement for an interfering magnetic field, the interfering magnetic field having an intensity sufficient to cause a compass measurement error, the system comprising:
a magnetic field sensor for measuring a magnetic field;
a compass control circuit coupled to the magnetic field sensor, the compass control circuit configured to control the magnetic field sensor and to process the magnetic field measured by the magnetic field sensor; and
wherein the compass control circuit is configured to determine a first magnetic field value and a second magnetic field value, such that the second magnetic field value is caused by a change in direction of the vehicle.

2. A system according to claim 1, wherein the compass control circuit determines a correction value based on the first magnetic field value and the second magnetic field value; and
wherein the correction value is stored in a memory.

3. A system according to claim 1, further including a wheel sensor, the wheel sensor being configured to determine whether the vehicle is changing direction.

4. A system according to claim 1, wherein the first magnetic field value relates to a vehicle accessory.

5. A system according to claim 1, wherein the first magnetic field value relates to compass error caused by an external magnetic influence.

6. A system according to claim 1, further including a vehicle speed sensor, the vehicle speed sensor being configured to provide a speed signal indicating a speed of the vehicle.

7. A system according to claim 1, further comprising a database, the database including a set of predetermined vehicle accessory magnetic field value characteristics.

8. A system according to claim 7, wherein the compass control circuit compares the first magnetic field value to the set of predetermined vehicle accessory magnet field value characteristics; and
wherein the compass control circuit transmits a weighted average correction signal when the first magnetic field value and the set of predetermined vehicle accessory magnet field value characteristics are related to a stable accessory.

9. A system according to claim 1, further comprising an accessory monitoring circuit coupled to the compass control circuit, the accessory monitoring circuit configured to monitor the vehicle accessory and to provide a signal to the compass control circuit instructing the compass control circuit to measure the first magnetic field value.

10. A system according to claim 1, further comprising a global positioning sensor, the global positioning sensor being configured to transmit data including at least one of a location position, a vehicle speed or a vehicle heading to compass control circuit;
wherein the compass control circuit compares the second magnetic field value to an actual magnetic field value at the magnetic field sensor and calculates a difference between the second magnetic field value and the actual magnetic field value at the magnetic field sensor; and
wherein the compass control circuit is configured to store the difference between the second magnetic field value and the actual magnetic field value at the magnetic field sensor in a database.

11. A method for correcting a vehicle compass measurement for an interfering magnetic field, the interfering magnetic field having an intensity sufficient to cause a compass measurement error, the method comprising:
monitoring an angular change of a vehicle;
detecting a first magnetic field value;
determining a second magnetic field value caused by the changing of direction of the vehicle based on the angular change of the vehicle;
determining a correction value based on the first magnetic field value and the second magnetic field value; and
storing the correction value in a memory.

12. A method according to claim 11, wherein the first magnetic field value relates to a vehicle accessory.

13. A method according to claim 11, wherein the first magnetic field value relates to compass error caused by an external magnetic influence.

14. A method according to claim 11, further comprising storing predetermined vehicle accessory magnetic field value characteristics in a database.

15. A method according to claim 11, further comprising an accessory monitoring circuit coupled to a compass control circuit, the accessory monitoring circuit configured to monitor a vehicle accessory and to provide a signal to the compass control circuit instructing the compass control circuit to measure the second magnetic field value.

16. A method according to claim 11, further comprising monitoring a vehicle speed.

17. A compass correction system, comprising:
a means for monitoring an angular change of a vehicle;
a means for detecting a first magnetic field value;
a means for determining a second magnetic field value caused by the changing of direction of the vehicle based on the angular change of the vehicle;
a means for determining a correction value based on the first magnetic field value and the second magnetic field value; and
a means for storing the correction value.

18. A compass correction system according to claim 17, wherein the first magnetic field value relates to a vehicle accessory.

19. A compass correction system according to claim 17, wherein the first magnetic field value relates to compass error caused by an external magnetic influence.

20. A vehicle compass system for compensating for magnetic field values, the vehicle compass system comprising:
a magnetic field sensor being configured to determine an orientation of the magnetic field sensor with respect to the Earth's magnetic field and to generate magnetic field data;
a control circuit coupled to a vehicle accessory and the magnetic field sensor, the control circuit being configured to receive a status signal from the vehicle accessory indicating whether the vehicle accessory has a status change, to receive magnetic field data from the magnetic field sensor, to receive a vehicle angular change signal from a vehicle angular change monitor; and
wherein when the vehicle angular change signal indicates a change in a vehicle angle, the control circuit is configured to determine a first magnetic field value and a second magnetic field value, such that the second magnetic field value is caused by a change in direction of the vehicle.

21. The vehicle compass system according to claim 20, wherein the control circuit determines a correction value based on the first magnetic field value and the second magnetic field value.
